(19) United States
(12) Patent Application Publication
(10) Pub. No.: US 2021/0261447 A1
(43) Pub. Date: Aug. 26, 2021

(54) TREATMENT SYSTEM AND TREATMENT PROCESS FOR REMOVING HARDNESS, SILICON, AND TURBIDITY FROM WASTEWATER HAVING HIGH SALT CONCENTRATION

(71) Applicant: KEYSINO SEPARATION TECHNOLOGY INC., Shanghai (CN)

(72) Inventors: Chengci Zhang, Shanghai (CN); Zuoyun He, Beijing (CN); Xinyan Cheng, Shanghai (CN); Yong Qian, Shanghai (CN)

(73) Assignee: KEYSINO SEPARATION TECHNOLOGY INC., Shanghai (CN)

(21) Appl. No.: 17/260,556

(22) PCT Filed: Sep. 19, 2019
(86) PCT No.: PCT/CN2019/106691

§ 371 Date: Jan. 15, 2021

(30) Foreign Application Priority Data
Mar. 14, 2019 (CN) 201910194206.5

(51) Int. Cl. C02F 1/52; C02F 5/06; C02F 1/44; B01D 61/14; B01D 65/02; B01D 71/36

(52) U.S. Cl. CPC C02F 1/5236; C02F 5/06; C02F 1/444; C02F 2101/10; B01D 61/147; B01D 65/02; B01D 71/36; B01D 61/145

(57) ABSTRACT

A treatment system for removing hardness, silicon, and turbidity from wastewater having a high salt concentration, comprising an integrated reaction apparatus comprising a reaction box and a chemical drug adding device, and a membrane separation apparatus comprising a membrane pool and a membrane component. The wastewater having the high salt concentration enters the reaction box; a required chemical drug is added to the wastewater by means of the chemical drug adding device; the chemical drug and the wastewater are fully mixed and reacted to produce different kinds of sludge particles; a sludge particle mixed liquid directly enters the membrane pool; under the action of an aeration device, the sludge particle mixed liquid is in a suspension state and uniform in concentration, and is screened and filtered by the membrane component; and produced water is discharged from the membrane pool, and intercepted sludge particles are discharged from the membrane pool.

### TECHNICAL FIELD

This invention relates to a water treatment process, especially relates to a treatment system and a treatment process for removing hardness, silicon, and turbidity from wastewater having a high salt concentration.

### BACKGROUND

Wastewater having a high salt concentration has the characteristics of high salt content, high hardness, high silicon, etc., and without properly treatment and utilization, it would not only waste water resources, but also cause serious environmental pollution. Therefore, the research and development of efficient, low consumption, safe, and economical water treatment process is an inevitable trend of the development of modern water treatment technology.

A common treatment method for the wastewater having the high salt concentration is “membrane-concentration+evaporative crystallization”. Nevertheless, a high concentration of calcium and magnesium ions and silica in the wastewater is easy to scale and causes the membrane pollution, which seriously affects the stable operation of the system, increases working intensity and operating costs, and severely limits the processing ability of the company in the wastewater having the high salt concentration. Therefore, in order to ensure the normal operation of subsequent membrane-concentration, it is necessary to remove calcium and magnesium ions and silica in the wastewater by a method of adding chemical drug. After adding chemical drug, it needs to process a solid-liquid separation pretreatment to enter the membrane-concentration process. The pretreatment effect would directly affect the efficiency and life of the membrane-concentration.

Up to now, the traditional pretreatment process is “clarifier+ultrafiltration membrane filter”, which removes most of the solid particles after standing precipitation in the clarifier, and then removes the remaining suspended solids in the water by the ultrafiltration membrane, so that the water quality meets the requirement of reverse osmosis inflow water. Nevertheless, the process is time-consuming that since the content of the hardness, silicon, etc., in the water quality of the inflow water is different, the particle size of the produced sludge (calcium carbonate sludge, magnesium hydroxide sludge, silicate sludge) and the required precipitation time and the retention of the sludge are different. Due to the fluctuation of the water quality of the inflow water, the process is prone to occur the situation of turning sludge over the box during the most projects, and the effect of the precipitation is relatively poor, which leads to the relatively poor anti-fluctuation and stability of the whole process operation. Chinese patent CN108751523A discloses a method of directly filtering wastewater having a high salt concentration after the chemical drug adding reaction with a tubular membrane apparatus. Although the method saves a footprint size and a precipitation time of a clarifier, the tubular membrane apparatus has a high energy consumption and a large footprint size.

In view of this, the present invention is presented.

### SUMMARY

The purpose of the present invention is to overcome the defects of the above-mentioned technology, and provide a treatment system and a treatment process for removing hardness, silicon, and turbidity from wastewater having a high salt concentration.

The present invention has the advantages of short process, small footprint size, low energy consumption, and stable operation, which could effectively remove the content of the hardness and silicon in the wastewater having the high salt concentration and ensure the stability of the subsequent treatment process of the membrane-concentration in the wastewater having high salt concentration.

The purpose of the present invention could be realized through the following technical approaches:

A treatment system for removing hardness, silicon, and turbidity from wastewater having a high salt concentration includes an integrated reaction apparatus and a membrane separation apparatus, the integrated reaction apparatus includes a reaction box and a chemical drug adding device configured to add a chemical drug into the reaction box, and the membrane separation apparatus includes a membrane pool, a membrane component disposed in the membrane pool and configured to separate the mixed liquid from the reaction box, and a produced water pipeline introducing from the membrane pool, a produced water pump is disposed on the produced water pipeline, a membrane pool inflow water pipeline is connected between the reaction box and the membrane pool and is configured to apply the reacted mixed liquid after adding the chemical drug into the reaction box directly into the membrane pool, a membrane pool inflow water pump is disposed on the membrane pool inflow water pipeline.

In one of the preferred embodiments of the present invention, baffles are disposed in the reaction box, which divide a part of the reaction box into chemical drug adding compartments, the baffles are staggered in the reaction box to form a channel for the solution to flow up and down in the reaction box.

The chemical drug adding compartments comprise a chemical drug adding chamber of softening chemical drug and a chemical drug adding chamber of removing silicon, and are not particularly limited thereto.

In one of the preferred embodiments of the present invention, a blender is disposed in the reaction box, and a reaction box sludge discharging bump is disposed at a bottom of the reaction box.

In one of the preferred embodiments of the present invention, one or more sets of the membrane component are disposed in the membrane pool.

In one of the preferred embodiments of the present invention, a material of the membrane component is polytetrafluoroethylene (PTFE), which has good resistance to acid and alkali, tolerates a long-term operation in the range of pH value between 1-14, without adjusting the pH value after adding chemical drug which directly contacts with the membrane component; at the same time, tolerates an immersion of sodium hypochlorite solution within 3000 ppm. There is no requirement for a chloride ion concentration and there is no chloride ion corrosion problem.

In one of the preferred embodiments of the present invention, the aperture of the membrane component is 0.01-0.5 μm. According to requirements, different aperture ranges are selected to meet the requirements of different particle sizes. The membrane aperture is in a range of 0.01-0.5 μm, far less than a softening generated particle diameter of calcium carbonate (more than 20 μm) and magnesium hydroxide (1-5 μm), far less than a particle diameter of a chelate generated from calcium magnesium silicate, and thus based on a principle of screening and filtration, directly intercepting the generated particles from the reaction at an outside of a membrane, and without considering the effect of precipitation time of precipitation separation and the fluctuation of the water quality with respect to precipitated particles in the traditional softening process (reaction-precipitation-filtration-ultrafiltration).

In one of the preferred embodiments of the present invention, a type of the membrane component comprises a plate type, a tubular type, a hollow fiber, a spiral wound type, etc., and is not particularly limited thereto.

In one of the preferred embodiments of the present invention, an aeration device and a membrane pool sludge discharging pump are disposed at the bottom of the membrane pool. The aeration device is configured to mix and stir, so that the sludge in the membrane pool is in a suspension state, uniform in concentration, and non-precipitating on a surface of the membrane, simultaneously, to scour the surface of the membrane to prevent a membrane pollution.

In one of the preferred embodiments of the present invention, a backwashing system and a chemical cleaning system are disposed on the produced water pipeline, the backwashing system comprises a backwashing water box and a backwashing pipeline between the backwashing water box and the produced water pipeline, a backwashing pump is disposed on the backwashing pipeline; the chemical cleaning system comprises an acid measuring box, an acid drug adding pump, an alkali measuring box, an alkali drug adding pump, a sodium hypochlorite measuring box, a sodium hypochlorite drug adding pump, etc. The backwashing water in the backwashing water box enters into the membrane separation apparatus through the backwashing pump to clean the membrane to ensure a separation efficiency of the membrane. According to requirements, the water in the backwashing water box is produced water or a certain acid, alkali, sodium hypochlorite solution under a regular preparation, etc., for backwashing.

The present invention also provides a treatment process for removing hardness, silicon, and turbidity from wastewater having a high salt concentration according to the treatment system, which comprises the following steps:

Entering wastewater having a high salt concentration into a reaction box, according to the requirements of wastewater water quality and produced water, adding a required chemical drug in the wastewater through a chemical drug adding device, fully mixing and reacting the chemical drug and the wastewater by stirring to produce different kinds of sludge particles, including calcium carbonate sludge, magnesium hydroxide sludge, silicate sludge to remove the hardness, silica, turbidity, etc., in the wastewater, and being not particularly limited thereto;

Directly entering a sludge particle mixed liquid into a membrane pool; under the action of an aeration device, sludge is in a suspension state and uniform in concentration, and is screened and filtered by a membrane component, produced water is discharged from the membrane pool through a produced water pump, intercepted sludge particles are discharged from membrane pool through a membrane pool sludge discharging pump; based on a principle of screening and filtration, the membrane separation apparatus directly intercepts the sludge particles of the mixed liquid at an outside of the membrane, the produced water is recycled, the sludge particles are discharged out of the membrane separation apparatus.

Wherein, the produced water meets the requirement of reverse osmosis inflow water.

In one of the preferred embodiments of the present invention, the required chemical drug includes a softening chemical drug, a silicon removing drug, and is not particularly limited thereto, the softening chemical drug comprises lime, sodium hydroxide, sodium carbonate, etc.

In one of the preferred embodiments of the present invention, the treatment process uses a method of continuous inflow water, and uses an operation method of continuous sludge discharging or intermittent sludge discharging.

In the present invention, the main apparatus obtains the following functions:

1. Reaction box: a reacting area of wastewater and chemical drug.

2. Chemical drug adding device: according to the wastewater water quality and the requirement of removing turbidity, removing hardness, and removing silicon, preparing a certain concentration of chemical drug, such as: lime, NaOH, Na₂CO₃, and magnesium drug in different kinds of required chemical drug.

3. Reaction box sludge discharging pump: quantitatively discharging sludge to keep the stable concentration of suspended solids (SS) of the wastewater in the membrane filtration area.

4. Blender: fully mixing the wastewater and the chemical drug to ensure the removal efficiency of calcium, magnesium, silicon, etc.

5. Membrane pool inflow water pump: quantitatively applying the wastewater after a chemical drug adding reaction into the membrane filtration device.

6. Membrane pool: an area of the membrane filtration device.

7. Membrane component: processing a solid-liquid separation of the wastewater after the chemical drug adding reaction to ensure that the produced water meets the water quality of the reverse osmosis inflow water.

8. Aeration device: ensuring the uniform in concentration of the wastewater in the membrane filtration area; scouring the surface of the membrane to prevent the membrane pollution.

9. Membrane pool sludge discharging pump: discharging the sludge particles intercepted from the membrane component out of the membrane pool.

10. Produced water pump: providing transmembrane pressure difference, and quantitatively outletting water.

11. Backwashing water box: regularly preparing a certain concentration of backwash water.

12. Backwashing pump: applying water in the backwashing water box to backwashing the membrane component.

13. Cleaning system: cleaning the membrane component.

Compared with that of related arts, the technical effects of the present invention are as follows:

1. The process of the present invention uses the combination of the integrated reaction apparatus and the membrane separation apparatus, is applied to soften and remove hardness of water having the high salt concentration, and has less process flow. However, the traditional process generally uses the combination of mixed reaction+precipitation+coarse filtration (sand filtration)+ultrafiltration (micro filtration).

2. The process flow of the present invention is greatly simplified than the traditional process, which does not need to consider the precipitation separation and multi-stage filtration of the sludge, with less equipment, small footprint size, short construction period, and low investment cost.

3. The process of the present invention uses the principle of screening and filtration to process the solid-liquid separation, directly intercepting the generated particles from the reaction at the outside of the membrane, and without consider the effect of precipitation time of precipitation separation and the fluctuation of the water quality with respect to precipitated particles in the traditional softening process (reaction-precipitation-filtration-ultrafiltration).

4. The process could effectively remove the content of the hardness, silicon, etc., in the wastewater having the high salt concentration, has low energy consumption, and processes 0.8-1 KWH of power consumption per ton of water. The combined process of the traditional mixing reaction+precipitation+coarse filtration (sand filtration)+ultrafiltration (micro filtration) processes 1.5 KWH of power consumption per ton of water and has a larger advantage in operating energy consumption.

5. The selected membrane of the present invention has the following two characteristics: \textcircled{1} The material of the membrane component is PTFE, which has good resistance to acid and alkali, operates in any range of pH value between 1-14, without adjusting the pH value after adding chemical drug which directly contacts with the membrane component; which has no requirement for a chloride ion concentration and there is no chloride ion corrosion problem. \textcircled{2} The aperture of the membrane component is in the range of 0.01-0.5 μm, which is far less than the softening generated particle diameter of calcium carbonate (more than 20 μm) and magnesium hydroxide (1-5 μm), and far less than the particle diameter of the chelate generated from calcium magnesium silicate, and thus based on the principle of screening and filtration, directly intercepting the generated particles from the reaction at the outside of the membrane, and without considering the effect of precipitation time of precipitation separation and the fluctuation of the water quality with respect to precipitated particles in the traditional softening process (reaction-precipitation-filtration-ultrafiltration).

### BRIEF DESCRIPTION OF THE DRAWINGS

FIG. 1 is a schematic diagram of a structure of a treatment system for removing hardness, silicon, and turbidity from wastewater having a high salt concentration in embodiment 1 of the present invention.

1 Reaction box; 2 Chemical drug adding device; 3 Reaction box sludge discharging pump; 4 Blender; 5 Membrane pool inflow water pump; 6 Membrane pool; 7 Membrane component; 8 Aeration device; 9 Membrane pool sludge discharging pump; 10 Produced water pump; 11 Backwashing water box; 12 Backwashing pump; 13 Chemical cleaning system.

### DESCRIPTION OF THE EMBODIMENTS

The present invention is described in detail below in combination with the drawings and the embodiments.

### Embodiment 1

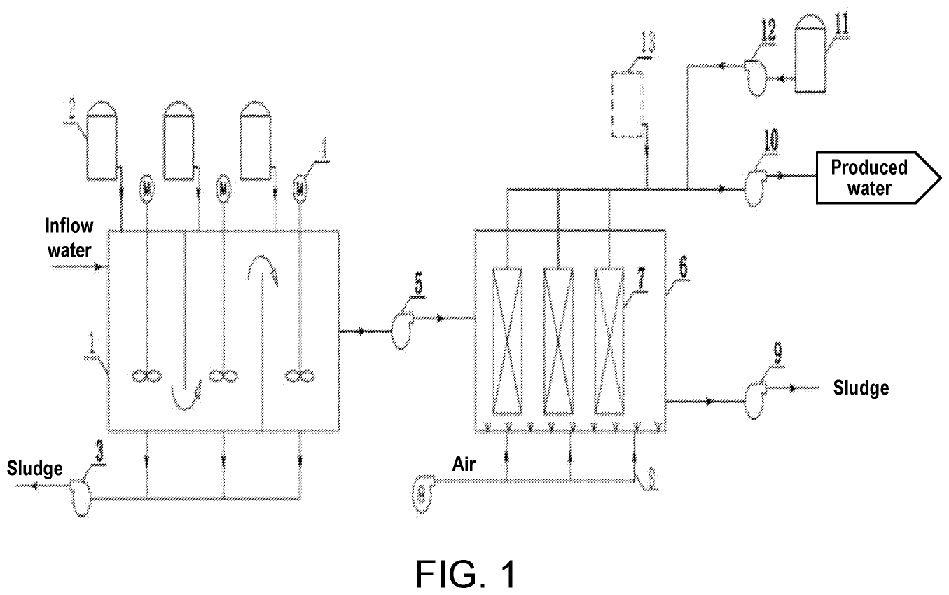

A treatment process for removing hardness, silicon, and turbidity from wastewater having a high salt concentration, as shown in FIG. 1, includes an integrated reaction apparatus and a membrane separation apparatus, the integrated reaction apparatus includes a reaction box 1 and a chemical drug adding device 2 configured to add a chemical drug into the reaction box 1, and the membrane separation apparatus includes a membrane pool 6, a membrane component 7 disposed in the membrane pool 6 and configured to separate the mixed liquid from the reaction box 1, and a produced water pipeline introducing from the membrane pool 6, a produced water pump 10 is disposed on the produced water pipeline, a membrane pool inflow water pipeline is connected between the reaction box 1 and the membrane pool 6 and is configured to apply the reacted mixed liquid after adding the chemical drug into the reaction box 1 directly into the membrane pool 6, a membrane pool inflow water pump 5 is disposed on the membrane pool inflow water pipeline.

In the embodiment, baffles are disposed in the reaction box 1, which divide a part of the reaction box into chemical drug adding compartments, the baffles are staggered in the reaction box 1 to form a channel for the solution to flow up and down in the reaction box. The chemical drug adding compartments comprise a chemical drug adding chamber of softening chemical drug and a chemical drug adding chamber of removing silicon, and are not particularly limited thereto.

In the embodiment, a blender 4 is disposed in the reaction box 1, and a reaction box sludge discharging bump 3 is disposed at a bottom of the reaction box 1.

In the embodiment, one or more sets of the membrane component 7 are disposed in the membrane pool 6.

In the embodiment, a material of the membrane component 7 is polytetrafluoroethylene (PTFE), which has good resistance to acid and alkali, tolerates a long-term operation in the range of pH value between 1-14, without adjusting the pH value after adding chemical drug which directly contacts with the membrane component; simultaneously, tolerates an immersion of sodium hypochlorite solution within 3000 ppm. There is no requirement for a chloride ion concentration and there is no chloride ion corrosion problem.

In the embodiment, an aperture of the membrane component 7 is 0.01-0.5 μm, according to requirements, different aperture ranges are selected to meet the requirements of different particle sizes. The membrane aperture is in a range of 0.01-0.5 μm, which is far less than a softening generated particle diameter of calcium carbonate (more than 20 μm) and magnesium hydroxide (1-5 μm), and far less than a particle diameter of a chelate generated from calcium magnesium silicate, and thus based on a principle of screening and filtration, directly intercepting the generated particles from the reaction at an outside of the membrane, and without considering the effect of precipitation time of precipitation separation and the fluctuation of the water quality with respect to precipitated particles in the traditional softening process (reaction-precipitation-filtration-ultrafiltration).

In the embodiment, a type of the membrane component 7 comprises a plate type, a tubular type, a hollow fiber, a spiral wound type, etc., and is not particularly limited thereto.

In the embodiment, an aeration device 8 and a membrane pool sludge discharging pump are disposed at the bottom of the membrane pool 6. The aeration device 8 is configured to mix and stir, so that the sludge in the membrane pool is in a suspension state, uniform in concentration, and non-precipitating on a surface of the membrane, simultaneously, to scour the surface of the membrane to prevent a membrane pollution.

In the embodiment, a backwashing system and a chemical cleaning system are disposed on the produced water pipeline, the backwashing system comprises a backwashing water box 11 and a backwashing pipeline between the backwashing water box 11 and the produced water pipeline, a backwashing pump 12 is disposed on the backwashing pipeline; the chemical cleaning system comprises an acid measuring box, an acid drug adding pump, an alkali measuring box, an alkali drug adding pump, a sodium hypochlorite measuring box, a sodium hypochlorite drug adding pump, etc. The backwashing water in the backwashing water box enters into the membrane separation apparatus through the backwashing pump to clean the membrane to ensure a separation efficiency of the membrane. According to requirements, the water in the backwashing water box is produced water or a certain acid, alkali, sodium hypochlorite solution under a regular preparation, etc., for backwashing.

The embodiment also provides a treatment process for removing hardness, silicon, and turbidity from wastewater having a high salt concentration according to the treatment system, which comprises the following steps:

Entering wastewater having a high salt concentration into a reaction box 1, according to the requirements of wastewater water quality and produced water, adding a required chemical drug in the wastewater through a chemical drug adding device 2, fully mixing and reacting the chemical drug and the wastewater by stirring to produce different kinds of sludge particles, including calcium carbonate sludge, magnesium hydroxide sludge, silicate sludge to remove the hardness, silica, turbidity, etc., in the wastewater;

Directly entering a sludge particle mixed liquid into a membrane pool 6; under the action of an aeration device, sludge is in a suspension state and uniform in concentration, screening and filtering by a membrane component 7, discharging produced water from the membrane pool 6 through a produced water pump 10, discharging intercepted sludge particles from membrane pool 6 through a membrane pool sludge discharging pump 9; based on a principle of screening and filtration in the membrane separation apparatus, directly intercepting the sludge particles of the mixed liquid at an outside of the membrane, recycling the produced water, discharging the sludge particles from the membrane separation apparatus.

Wherein, the produced water meets the requirement of reverse osmosis inflow water. The required chemical drug includes a softening chemical drug, a silicon removing drug, and is not particularly limited thereto, the softening chemical drug comprises lime, sodium hydroxide, sodium carbonate, etc. The treatment process uses a method of continuous inflow water, and uses an operation method of continuous sludge discharging or intermittent sludge discharging.

### Embodiment 2

A coal chemical industry contains wastewater having a high salt concentration with a TDS content of 35000 mg/L, a SiO₂ concentration of 80 mg/L, a hardness of around 5 mmol/L, which belongs to wastewater having a high salt, high silicon, and high hardness. After using the treatment process for removing hardness, silicon, and turbidity from wastewater having the high salt concentration according to embodiment 1, an inflow water SS concentration is 1.2-2.5 g/L, a membrane filtration area wastewater SS concentration is condensed to 15.5-33 g/L, a concentration factor is 10-20 times. In produced water, SiO₂ is less than 18 mg/L, hardness is less than 0.5 mmol/L, SDI remains 3-5, and turbidity is less than 1 NTU, the produced water could directly enter to the subsequent reverse osmosis treatment process.

### Embodiment 3

In wastewater having a high salt concentration, a TDS content is 45000 mg/L, a SiO₂ concentration is 150 mg/L, and a hardness is around 8 mmol/L, belonging to wastewater having a high salt, high silicon, and high hardness. After using the treatment process for removing hardness, silicon, and turbidity from wastewater having the high salt concentration according to embodiment 1, in produced water, SiO₂ is less than 15 mg/L, hardness is less, SDI is in a range of 3-5, and turbidity is less than 0.5 NTU. The produced water enters to the subsequent reverse osmosis treatment process, an operation stability of the reverse osmosis system is good, and a stability of a cleaning cycle is more than 1.5 months.

### Embodiment 4

In wastewater having a high salt concentration, a TDS content is 50000 mg/L, a SiO₂ concentration is 400 mg/L, and a hardness is around 10 mmol/L, belonging to wastewater having a high salt, high silicon, and high hardness. After using the treatment process for removing hardness, silicon, and turbidity from wastewater having the high salt concentration according to embodiment 1, in produced water, SiO₂ is less than 30 mg/L, hardness is less than 0.8 mmol/L, SDI is less than 5 and equal to 5, and turbidity remains less than 0.5 NTU.

The above description of the embodiments is intended to facilitate the understanding and use of the present invention by ordinary technicians in the technical field. Person skilled in the art can obviously and easily make various modifications to these embodiments and apply the general principles described here to other embodiments without creative labor. Therefore, the present invention is not limited to the above embodiments, and according to the disclosure of the present invention, the improvements and modifications made by practitioners skilled in the art without departing from the spirit of the present invention should fall within the scope of the present invention for which protection is sought.

1. A treatment system for removing hardness, silicon, and turbidity from wastewater having a high salt concentration, comprising an integrated reaction apparatus and a membrane separation apparatus,
wherein the integrated reaction apparatus comprises:
a reaction box; and
a chemical drug adding device, configured to add a chemical drug into the reaction box,
wherein the membrane separation apparatus comprises:
a membrane pool;
a membrane component, disposed in the membrane pool and configured to separate the mixed liquid from the reaction box; and
a produced water pipeline, introducing from the membrane pool,
wherein a membrane pool inflow water pipeline is connected between the reaction box and the membrane pool and is configured to apply the reacted mixed liquid after adding the chemical drug into the reaction box directly into the membrane pool.

2. The treatment system for removing hardness, silicon and turbidity from wastewater having high salt concentration according to claim 1,
wherein baffles are disposed in the reaction box, the baffles divide a part of the reaction box into chemical drug adding compartments, the baffles are staggered in the reaction box to form a channel for the solution to flow up and down in the reaction box.

3. The treatment system for removing hardness, silicon and turbidity from wastewater having high salt concentration according to claim 1,
wherein a blender is disposed in the reaction box, the blender fully mixes and stirs after adding the chemical drug to prevent the generated particles to precipitate, and remains inflow water in the reaction box for enough time to fully apply a chemical reaction in the reaction box,
wherein a reaction box sludge discharging bump is disposed at a bottom of the reaction box.

4. The treatment system for removing hardness, silicon and turbidity from wastewater having high salt concentration according to claim 1,
wherein one or more sets of the membrane component are disposed in the membrane pool.

5. The treatment system for removing hardness, silicon and turbidity from wastewater having high salt concentration according to claim 1,
wherein a material of the membrane component is polytetrafluoroethylene, which tolerates a long-term operation in a range of pH value between 1-14, and an immersion of sodium hypochlorite solution within 3000 ppm.

6. The treatment system for removing hardness, silicon and turbidity from wastewater having high salt concentration according to claim 1,
wherein an aperture of the membrane component is 0.01-0.5 μm.

7. The treatment system for removing hardness, silicon and turbidity from wastewater having high salt concentration according to claim 1,
wherein an aeration device and a membrane pool sludge discharging pump are disposed at a bottom of the membrane pool, so that the sludge particle mixed liquid in the membrane pool is in a suspension state, and non-attached on a surface of a membrane of the membrane component.

8. The treatment system for removing hardness, silicon and turbidity from wastewater having high salt concentration according to claim 1,
wherein a backwashing system and a chemical cleaning system are disposed on the produced water pipeline,
wherein the backwashing system comprises:
a backwashing water box; and
a backwashing pipeline, which is connected between the backwashing water box and the produced water pipeline, and which a backwashing pump is disposed on,
wherein the chemical cleaning system comprises:
an acid measuring box;
an acid drug adding pump;
an alkali measuring box;
an alkali drug adding pump;
a sodium hypochlorite measuring box; and
a sodium hypochlorite drug adding pump.

9. The treatment process for removing hardness, silicon and turbidity from wastewater having high salt concentration according to the treatment system of claim 1, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

10. The treatment process for removing hardness, silicon and turbidity from wastewater having high salt concentration according to claim 9,
wherein the treatment process uses a method of continuous inflow water, and uses an operation method of continuous sludge discharging or intermittent sludge discharging.

11. The treatment process for removing hardness, silicon and turbidity from wastewater having high salt concentration according to the treatment system of claim 2, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

12. The treatment process for removing hardness, silicon and turbidity from wastewater having high salt concentration according to the treatment system of claim 3, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

13. The treatment process for removing hardness, silicon and turbidity from wastewater having high salt concentration according to the treatment system of claim 4, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

14. The treatment process for removing hardness, silicon and turbidity from wastewater having high salt concentration according to the treatment system of claim 5, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

15. The treatment process for removing hardness, silicon and turbidity from wastewater having high salt concentration according to the treatment system of claim 6, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

16. The treatment process for removing hardness, silicon and turbidity from wastewater having high salt concentration according to the treatment system of claim 7, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.

17. The treatment process for removing hardness, silicon and turbidity from wastewater having high salt concentration according to the treatment system of claim 8, comprising the following steps:
entering wastewater having a high salt concentration into a reaction box, adding a required chemical drug in the wastewater through a chemical drug adding device, and fully mixing and reacting the chemical drug and the wastewater to produce different kinds of sludge particles;
directly entering a sludge particle mixed liquid into a membrane pool, wherein under an action of an aeration device, the sludge particle mixed liquid is in a suspension state and uniform in concentration, and is screened and filtered by a membrane component, produced water is discharged from the membrane pool, intercepted sludge particles are discharged from membrane pool;
wherein the produced water meets the requirement of reverse osmosis inflow water.
